(19) United States
(12) Patent Application Publication
(10) Pub. No.: US 2017/0158931 A1
(43) Pub. Date: Jun. 8, 2017

(54) Salt Mixture

(71) Applicant: Siemens Aktiengesellschaft, Münich (DE)

(72) Inventors: Pascal Heilmann, Lauter (DE); Edwin Roovers, Leiden (NL); Steven de Wispelaere, Leiden (NL); Matthias Uebler, Ursensollen (NL)

(73) Assignee: Siemens Aktiengesellschaft, Münich (DE)

(21) Appl. No.: 15/325,613

(22) PCT Filed: May 20, 2015
(86) PCT No.: PCT/EP2015/061159

§ 371 Date: Jan. 11, 2017

(30) Foreign Application Priority Data
Jul. 16, 2014 (EP) 14177276.4

(51) Int. Cl. C09K 5/06; C09K 5/12

(52) U.S. Cl. CPC C09K 5/063; C09K 5/12

(57) ABSTRACT

A mixture of inorganic nitrate salts may include sodium nitrate and potassium nitrate in certain proportions which can be used both for the storage of thermal energy and as heat transfer fluid, for example within concentrated solar power (CSP) plants. Such mixture may be used, for example, in thermodynamic solar systems with point-focusing, receiver-type power towers using heliostat mirror geometries on-ground. As another example, the disclosed mixture may be used as heat transfer fluid in a number of applications for industrial processes involving heat exchanges in a wide range of temperatures. One example mixture is an anhydrous, binary salt mixture, comprising potassium nitrate KNO₃ and sodium nitrate NaNO₃ wherein the KNO₃ content ranges from 60% by weight to 75% by weight, e.g., from 63% by weight to 70% by weight, e.g., from 65% by weight to 68% by weight.

### CROSS-REFERENCE TO RELATED APPLICATIONS

This application is a U.S. National Stage Application of International Application No. PCT/EP2015/061159 filed May 20, 2015, which designates the United States of America, and claims priority to EP Application No. 14177276.4 filed Jul. 16, 2014, the contents of which are hereby incorporated by reference in their entirety.

### TECHNICAL FIELD

The present invention relates to a mixture of inorganic nitrate salts comprising sodium nitrate and potassium nitrate in certain proportions which can be used both for the storage of thermal energy and as heat transfer fluid, for example within concentrated solar power (CSP) plants. The present invention may be used, e.g., in thermodynamic solar systems with point-focusing, receiver-type power towers using heliostat mirror geometries on-ground.

The present invention may furthermore be used as heat transfer fluid in a number of applications for industrial processes involving heat exchanges in a wide range of temperatures.

### BACKGROUND

Renewable energy from solar power towers is anticipated to be able to satisfy a significant portion of the energy demand in the upcoming decades. This form of emission-free, concentrating solar power (CSP) utilizes a multitude of so-called heliostats, i.e. sun-tracking, flat mirror geometries that focus the incident sun rays by reflection onto a spot located in the very top of a nearby solar tower. This so-called receiver is a highly sophisticated assembly in which a confined heat transfer fluid is heated up to high bulk temperatures, usually approximately 565° C. The hot heat transfer fluid is then pumped to a heat-exchanger of an ordinary water/steam cycle, in which feed water is vaporized via a three-stage process by an economizer, evaporator and super-heater section. The steam is then fed through a turbine to provide electricity by means of a generator. The supplied energy is then fed into the electrical power grid.

In order to be able to also produce electricity in the absence of sun (e.g. at night, during shady periods or prolonged bad weather periods) the heat transfer fluid is not only used to harvest heat in the receiver system in the power tower but also to store thermal energy. For this purpose, most of the hot heat transfer fluid is stored in large tanks. By doing so during sunny periods, the thermal storage system is charged with heat for later dispatch by feeding the then hot transfer fluid to the water/steam-cycle. This setup is known as a direct two-tank CSP system.

As the heat transfer fluid is being heated up to temperatures of roughly 565° C. in daily cycles, the medium has to meet several requirements such as thermal stability, specific heat capacity, dynamic viscosity, thermal conductivity, vapor pressure and cost for continuous operation during a typical 30-year lifetime.

Prior art direct two-tank CSP systems typically employ molten salt mixtures as heat transfer fluid and thermal energy storage medium. A well known salt mixture, often referred to as Solar Salt, comprises sodium nitrate (NaNO₃) and potassium nitrate (KNO₃), wherein the NaNO₃ content is 60% by weight and the KNO₃ content is 40% by weight. This mixture has a liquid us temperature of 238° C. and combines a high thermal stability at temperatures of up to ˜585° C. and a large specific heat capacity of roughly

$$1.55 \frac{kJ}{kg \cdot K}$$

with a thermal conductivity of

$$0.5 \frac{W}{m \cdot K}$$

and a dynamic viscosity of approximately 3 mPa•s at 300° C., while being non-toxic, low in corrosion tendency towards austenitic stainless steels and relatively cheap in salt investment costs. It is not only used in tower CSP systems but also as thermal energy storage medium in the known parabolic trough CSP plants with thermal storage capability.

Solar Salt, when exposed to air, starts decomposing irreversibly to alkali oxides via nitrites at about 600° C. The same is true for other known NaNO₃/KNO₃ mixtures such as eutectic NaNO₃/KNO₃ having a liquids temperature of approximately 223° C.

Using fluids that can sustain even higher maximum temperatures is highly desirable as the Carnot efficiency of the overall system increases with the maximum temperature in the cycle.

One promising class of fluids contain the chlorides of lithium, sodium, potassium, caesium and/or strontium in the proper eutectic composition. Such fluids liquefy at temperatures of around 250° C. and do not decompose at temperatures of up to 700° C. and in some cases above. However, these fluids have several disadvantages. Components such as LiCl or CsCl are expensive or even unavailable in larger quantities. Also, chlorides demand expensive stainless steels to handle the corrosion and chromium depletion accompanied by liquid chloride attack. The tank system must not get into contact with any water since corrosion tendency accelerates tremendously when in contact with moisture, simultaneously forming hazardous, gaseous hydrogen chloride when overheated. Generally speaking, the disadvantages in using salt mixtures containing chlorides outweigh the advantages.

### SUMMARY

One embodiment provides an anhydrous, binary salt mixture comprising potassium nitrate KNO₃ and sodium nitrate NaNO₃, wherein the KNO₃ content ranges from 65% by weight to 68% by weight.

In one embodiment, the KNO₃ content is 66.6% by weight and the NaNO₃ content is 33.4% by weight.

In one embodiment, the liquids temperature ranges from 235° C. to 250° C.

In one embodiment, the heat of fusion is less than 100 J/g.

In one embodiment, the equilibrium constant K at 600° C. at equilibrium conditions is equal to or higher than 20 1/\sqrt{bar}.

In one embodiment, the weight loss is lower than 3% with respect to the initial weight for temperatures of approximately 635° C.

Another embodiment provides for a use of the mixture as disclosed above to transfer and/or store thermal energy.

In one embodiment, the mixture us used to transfer and/or store thermal energy in concentrated solar power plants.

In one embodiment, the mixture is used to transfer and/or store thermal energy in concentrated solar power plants with a power tower receiver unit.

Another embodiment provides a heat transfer and/or thermal-energy storage fluid comprising the mixture as disclosed above.

Another embodiment provides a heat transfer process wherein the heat transfer fluid comprises the salt mixture as disclosed above, wherein it operates in the temperature range from 250° C. to 640° C., including the interval bounds.

In one embodiment, the heat transfer process operates at a bulk temperature of at least 575° C. and a film temperature of at least 620° C.

In one embodiment, the heat transfer process operates at a bulk temperature of at least 585° C. and a film temperature of at least 620° C.

In one embodiment, the salt mixture is heated up to a film temperature in the range of 620° to 640°, including the interval bounds, and that the heating ramp from 300° C. to 640° C. may be in the range of 100-1500 K/min, e.g., in the range of 300-1300 K/min, e.g., in the range of 500-1100 K/min during non-equilibrium conditions.

In one embodiment, internal pump pressure and/or applied air and/or pure oxygen gas phase pressure may be in the range of 1-40 bar, e.g., in the range of 1.5-30 bar, e.g., in the range of 2-25 bar.

Another embodiment provides a concentrated solar power plant comprising at least a receiving pipe wherein the heat transfer fluid as disclosed above, and/or at least a collecting device wherein the thermal energy storage fluid as disclosed above is accumulated.

In one embodiment of the concentrated solar power plant, the accumulated thermal energy storage fluid is heated up to a bulk temperature in the range of 575° C. to 595° C., including the interval bounds, and stored in the collecting device at steady-state conditions for later dispatch into a water/steam-cycle heat exchanger.

In one embodiment of the concentrated solar power plant, the accumulated thermal energy storage fluid is heated up to a bulk temperature of 585° C. and stored in the collecting device at steady-state conditions for later dispatch into a water/steam-cycle heat exchanger.

### BRIEF DESCRIPTION OF THE DRAWINGS

Example aspects and embodiments of the invention are described in detail below with reference to the accompanying drawings, in which:

FIG. 1 shows the melting and solidification behavior of the mixture in accordance with an embodiment of the present invention in comparison to Solar Salt;

FIG. 2 shows the specific density of the mixture in accordance with an embodiment of the present invention plotted vs. temperature;

FIG. 3 shows the dynamic viscosity of the mixture in accordance with an embodiment of the present invention plotted vs. temperature;

FIG. 4 shows the thermal conductivity of the mixture in accordance with an embodiment of the present invention plotted vs. temperature;

FIG. 5 shows the specific heat capacity of the mixture in accordance with an embodiment of the present invention plotted vs. temperature; and

FIG. 6 shows key characteristics of the mixture in accordance with an embodiment of the present invention in comparison to Solar Salt in tabular form.

### DETAILED DESCRIPTION

Embodiments of the present invention may provide a salt mixture that can sustain higher temperatures than the well-known 60/40 mixture of NaNO₃ and KNO₃ by weight while at the same time avoiding the disadvantages that come with the use of chlorides in such salt mixtures.

Some embodiments provide an anhydrous, binary salt mixture, comprising potassium nitrate KNO₃ and sodium nitrate NaNO₃ wherein the KNO₃ content ranges from 60% by weight to 75% by weight, e.g., from 63% by weight to 70% by weight, e.g., from 65% by weight to 68% by weight.

In one embodiment the KNO₃ content is 66.6% by weight and the NaNO₃ content is 33.4% by weight.

Some embodiments also relate to the use of the salt mixture for transferring and/or storing energy; a heat transfer and/or thermal-energy storage fluid; a heat transfer process; and a concentrated solar power plant.

Advantageously, the disclosed salt mixture may employ the same inexpensive components, i.e. sodium nitrate and potassium nitrate as the well-known Solar Salt and can therefore be manufactured at low cost.

Surprisingly, the salt mixture in accordance with the present invention has almost identical thermo-physical properties (melting point, specific heat capacity, thermal conductivity and dynamic viscosity) but can sustain temperatures of up to 640° C. (film temperature) with no or minimal decomposition. Allowing for a safety margin, the maximum system temperature can thus be increased to 620° C. film temperature. The storage temperature can be increased to 585° C. bulk temperature, such that for both thermal energy transfer and thermal energy storage a surplus of 20 Kelvin is gained in contrast to the prior art technology which operates at 565° C. bulk temperature and 600° C. maximum film temperature.

Advantageously, when compared to the prior art technology, a mixture in accordance with the present invention exhibits a substantially diminished, almost halved NaNO₃ content and is therefore significantly more stable at high temperatures, especially when high heating rates are applied. This is due to the fact that among NaNO₃ and KNO₃, NaNO₃ is the less stable compound.

The nitrate/nitrite equilibrium, expressed as

NO₂_{^{−}}+0.5 O₂ [symbol] NO₃_{^{−}} (1)

shifts in favor of NO₂_{^{−}} at higher temperatures. Higher heating rates may further increase the stability of the mixture due to non-equilibrium conditions.

Embodiments of the present invention relate to a KNO₃-enriched formulation of the NaNO₃/KNO₃ binary system having a KNO₃ content of at least 60% by weight. In one embodiment the KNO₃ content is 66.6% by weight and the NaNO₃ content is 33.4% by weight. It should be noted that there may be technical or other reasons for deviating from the preferred ratio and that such deviations are well within the scope of the present invention.

For example there may be imperfections in each step of the manufacturing process of either component NaNO₃ or KNO₃, and there may be further imperfections in mixing the two solid components. The components may also be impure to a certain extent, depending for example on the quality of the used raw materials. While such imperfections or impurities may lead to a slightly decreased performance of the mixture it may still bear the lesser overall cost to employ an imperfect manufacturing process and accept the decreased performance. For the purposes of the present invention, a binary salt mixture of N % NaNO₃ and M % KNO₃ mixture shall mean a mixture of essentially N % NaNO₃ and M % KNO₃ in the sense that N may deviate by ±n and M may deviate by ±m where n and m represent aforementioned impurities and imperfections. Note that in practical applications N+M cannot always be 100%, for example due to the presence of impurities.

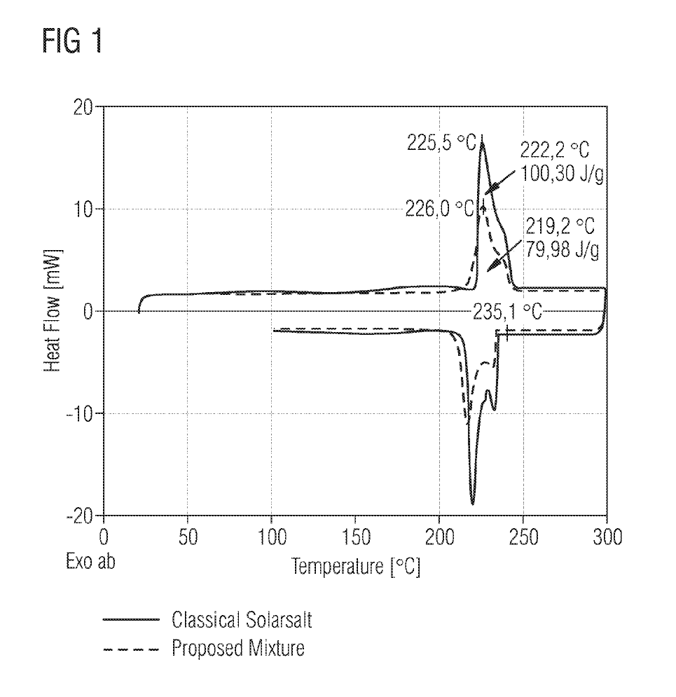

Referring now to FIG. 1, there is shown the melting and solidification behavior of a mixture having a KNO₃ content of 66.6% by weight and a NaNO₃ content of 33.4% by weight (dashed line). Also shown in FIG. 1 is the melting and solidification behavior of Solar Salt having a KNO₃ content of 40% by weight and a NaNO₃ content of 60% by weight (solid line). Both mixtures melt and solidify at almost the same temperature (225.5° C. and 226° C., respectively) which is an important fact as it facilitates retrofitting existing systems with the novel mixture. More importantly, the novel mixture has a 20% lower heat of fusion compared to Solar Salt meaning that less energy is required to affect the phase change from solid to liquid.

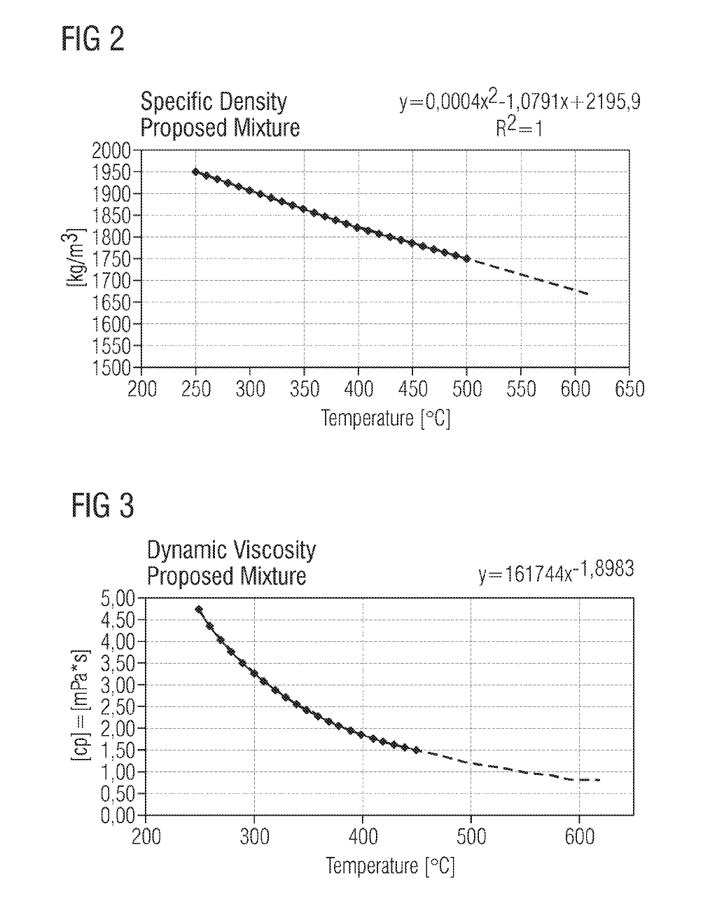

Referring now to FIG. 2, there is shown the specific density of the mixture in accordance with the present invention plotted vs. temperature. The specific density of the novel mixture almost linearly decreases as the temperature increases.

Referring now to FIG. 3, there is shown the dynamic viscosity of the mixture in accordance with the present invention plotted vs. temperature. As can be seen from FIG. 3 the dynamic viscosity decreases in non-linear fashion as the temperature increases.

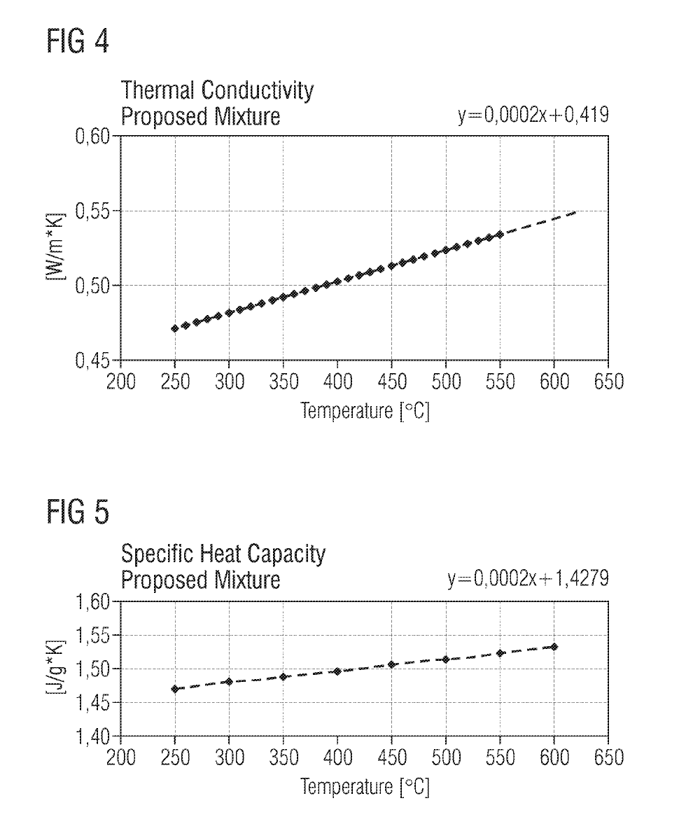

Referring to FIG. 4, there is shown the thermal conductivity of the mixture in accordance with the present invention plotted vs. temperature. In detail, the thermal conductivity slightly increases with the temperature.

Referring to FIG. 5, there is shown the specific heat capacity of the mixture in accordance with the present invention plotted vs. temperature. The specific heat capacity also increases slightly with the temperature.

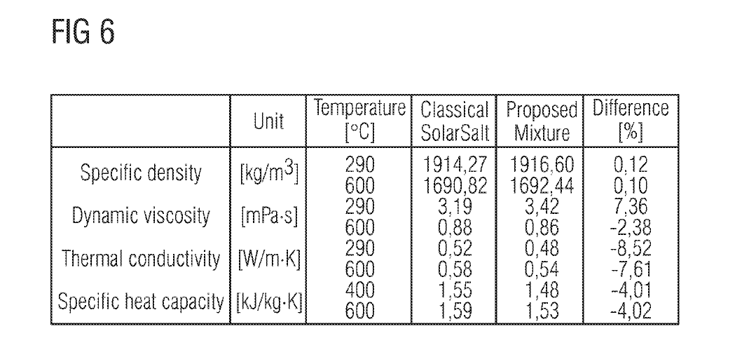

Referring to FIG. 6, there are shown some key characteristics of the mixture in accordance with the present invention in comparison to Solar Salt. Notably, the specific heat capacity of the novel mixture is about 4% lower than that of Solar Salt which means that about 4% more novel mixture is required to replace any given amount of Solar Salt in terms of accumulated enthalpy.

As discussed above, the novel mixture has a more favorable (i.e. lower) decomposition tendency into nitrites at film temperatures of 620° C. or higher. By applying pump pressures in the CSP system's receiver unit of 20-30 bar or more, this tendency can be diminished further.

Exploiting the thermo-physical properties of the novel mixture, an extra of 20 Kelvin in maximum operational temperature during steady-state conditions can be achieved, enhancing the thermal stability limit to 585° C. as bulk temperature. Also, covering and/or bubbling the storage tanks with air or pure oxygen at atmospheric pressure significantly reduces the rate of nitrite formation while keeping the mixture at said 585° C. bulk temperature (in some embodiments at a bulk temperature in the range from 575° C. to 595° C., in other embodiments at a bulk temperature in the range from 580° C. to 590° C., and in yet other embodiments at a bulk temperature from 583° C. to 587° C.) during day-charge. A system's thermal storage capability can be enhanced using the present invention as less salt is needed owing to the increased operating temperature span, thus compensating to some extent the effect described with reference to FIG. 6.

Moreover, since the ultimate heat-up stage of the molten salt formulation to approximately 620-640° C. film temperature in the power tower receiver is realized by a sharp temperature transient for a very short time (corresponding to a high heating rate), this overheating, non-equilibrium procedure can be limited to a very short time frame. The present invention allows for an enhanced heat up to higher film temperatures compared to the prior art. With the application of pump pressures and/or covering with pressurized air and/or oxygen, the equilibrium condition (see chemical equation (1) above) of the nitrate decomposition is not reached and thus thermal degradation can be limited or even avoided.

The equilibrium constant K of the chemical reaction represented by equation (1) can be expressed as follows:

$$K = \frac{[ {NO}_{3}^{-} ]}{[ {NO}_{2}^{-} ]} \cdot {( \sqrt{{p}_{{O}_{2}}} )}^{- 1} \qquad ( 2 )$$

wherein p_{O}_{₂} represents the oxygen pressure and wherein K is expressed in units of 1/\sqrt{bar}. For the eutectic mixture comprised of approximately equal molar portions of KNO₃ and NaNO₃, K is 18 . . . 20 1/\sqrt{bar} at 600° C.

Evidently, the increase of the maximum allowable bulk and film temperature will increase the Carnot efficiency of the system, resulting in a decreased amount of salt required to generate and store an equivalent amount of output power.

As discussed with reference to FIG. 1, the inventive mixture also exhibits a 20% decrease in apparent heat of fusion due to its reduced NaNO₃ content but, as discussed with reference to FIG. 6, has a 4% lower specific heat capacity, the effects of which are compensated to some extent by the increased temperature range. Consequently, the very first melt-up procedure (i.e. the step of preparing the molten salt for the first time in the storage tanks) consumes approximately 16.5% less natural gas when the mixture in accordance with the present invention is used instead of Solar Salt.

Consider the following example:

A CSP plant with 1300 MWh (thermal) energy storage capacity (corresponding to 8 hours of thermal storage at 50 MW (electrical) output with a power block net efficiency of approximately 40%), employing classical Solar Salt with a heat of fusion of approximately 100 kJ/kg (equivalent to 27.8 kWh/ton), will require approximately 11415 metric tons of salt.

For a CSP plant of equal dimensions, employing the inventive mixture with a heat of fusion of approximately 80 J/g (equivalent to 22.2 kWh/ton), approximately 11917 metric tons of the salt mixture will be required (due to its 4% reduced specific heat capacity). Additionally, in an event of an accidental freeze-up, the mixture in accordance with the present invention will liquefy faster and more easily than Solar Salt.

What is claimed is:

1. An anhydrous, binary salt mixture, comprising:
potassium nitrate KNO₃, and
sodium nitrate NaNO₃,
wherein the KNO₃ content ranges from 65% by weight to 68% by weight.

2. The salt mixture of claim 1, wherein the KNO₃ content is 66.6% by weight and the NaNO₃ content is 33.4% by weight.

3. The salt mixture of claim 1, wherein the liquids temperature ranges from 235° C. to 250° C.

4. The salt mixture of claim 1, wherein the heat of fusion is less than 100 J/g.

5. The salt mixture of claim 1, wherein the equilibrium constant K at 600° C. at equilibrium conditions is equal to or higher than 20 1/\sqrt{bar}.

6. The salt mixture of claim 1, wherein the weight loss is lower than 3% with respect to an initial weight for temperatures of approximately 635° C.

7. An energy management method, comprising:
collecting thermal energy; and
storing or transferring the collected thermal energy using anhydrous, binary salt mixture, comprising:
potassium nitrate KNO₃, and
sodium nitrate NaNO₃,
wherein the KNO₃ content ranges from 65% by weight to 68% by weight.

8. The method of claim 7, comprising collecting the thermal energy by a concentrated solar power plant.

9. The method of claim 8, wherein the concentrated solar power plant includes a power tower receiver unit.

10. (canceled)

11. A heat transfer process, comprising:
storing thermal energy in a heat transfer fluid comprising an anhydrous, binary salt mixture, comprising:
potassium nitrate KNO₃, and
sodium nitrate NaNO₃,
wherein the KNO₃ content ranges from 65% by weight to 68% by weight;
using the heat transfer fluid to transfer the stored thermal energy in the temperature range from 250° C. to 640° C., including the interval bounds.

12. The heat transfer process of claim 11, wherein the heat transfer is performed at a bulk temperature of at least 575° C. and a film temperature of at least 620° C.

13. The heat transfer process of claim 11, wherein the heat transfer is performed at a bulk temperature of at least 585° C. and a film temperature of at least 620° C.

14. The heat transfer process of claim 11, comprising heating the salt mixture to a film temperature in the range of 620° to 640°, including the interval bounds, wherein the salt mixture is heated from 300° C. to the film temperature at a heating rate in the range of 100-1500 K/min during non-equilibrium conditions.

15. The heat transfer process of claim 11, comprising setting an operational pressure for the heat transfer process in the range of 1-40 bar, wherein the operational pressure is an internal pump pressure, an applied air, or a pure oxygen gas phase pressure.

16. A concentrated solar power plant, comprising at least one of:
a receiving pipe that carries a heat transfer fluid comprising an anhydrous, binary salt mixture, comprising:
potassium nitrate KNO₃, and
sodium nitrate NaNO₃,
wherein the KNO₃ content ranges from 65% by weight to 68% by weight; or
a collecting device that accumulates a thermal energy storage fluid comprising the anhydrous, binary salt mixture.

17. The concentrated solar power plant of claim 16, wherein the accumulated thermal energy storage fluid is heated up to a bulk temperature in the range of 575° C. to 595° C., including the interval bounds, and stored in the collecting device at steady-state conditions for later dispatch into a water/steam-cycle heat exchanger.

18. The concentrated solar power plant of claim 16, wherein the accumulated thermal energy storage fluid is heated up to a bulk temperature of 585° C. and stored in the collecting device at steady-state conditions for later dispatch into a water/steam-cycle heat exchanger.

19. The heat transfer process of claim 11, wherein the salt mixture is heated from 300° C. to the film temperature at a heating rate in the range of 300-1300 K/min during non-equilibrium conditions.

20. The heat transfer process of claim 11, wherein the salt mixture is heated from 300° C. to the film temperature at a heating rate in the range of 500-1100 K/min during non-equilibrium conditions during non-equilibrium conditions.

21. The heat transfer process of claim 15, comprising setting the operational pressure for the heat transfer process in the range of 2-25 bar.

22. The heat transfer process of claim 15, comprising setting the operational pressure for the heat transfer process in the range of 1.5-30 bar.
